(19) United States
(12) Patent Application Publication
(10) Pub. No.: US 2025/0377051 A1
(43) Pub. Date: Dec. 11, 2025

(54) VALVE BODY FOR A PROCESS VALVE, AND PROCESS VALVE

(71) Applicant: GEMÜ Gebr. Müller Apparatebau GmbH & Co. Kommanditgesellschaft, Ingelfingen (DE)

(72) Inventors: Johann Magej, Schwäbisch Hall (DE); Elena Zuck, Bad Wimpfen (DE); Marcus Mager, Bad Rappenau (DE)

(21) Appl. No.: 19/219,164

(22) Filed: May 27, 2025

(30) Foreign Application Priority Data
Jun. 6, 2024 (DE) 10 2024 115 894.8

(51) Int. Cl. F16K 49/00; F16K 27/02

(52) U.S. Cl. CPC F16K 49/002; F16K 27/0236

(57) ABSTRACT

A valve body for a process valve is provided. An opening of the valve body leads to a fixed valve seat, and at least two fluid channel portions extend from the fixed valve seat into the valve body. At least one wall separates one of the fluid channel portions from a dry side of the valve body. At least one surface on the dry side of the wall is thermally conductively connected to at least one thermoelectric module.

### TECHNICAL FIELD

This disclosure relates to advances in the field of process valve technology.

### BACKGROUND

A process valve is an essential control and/or regulating element in industrial process plants and has the task of regulating, controlling, or blocking the flow of process media, such as liquids, gases, vapors, within a piping system. This is done by changing the flow opening, which is adjusted by the valve itself or by an external control unit.

The mode of operation of a process valve is usually based on a movable shut-off device (e.g., a flap, valve diaphragm, seat valve, ball, or cone), which changes its position relative to the valve body and thereby increases, decreases, or completely prevents the flow cross-section and thus the flow of the medium. The shut-off unit can be actuated manually via handwheels or levers or automatically by means of pneumatic, hydraulic, or electric actuators, depending on the application requirement.

### SUMMARY

This disclosure relates to a valve body for a process valve that includes a thermoelectric module thermally connected to a wall separating the fluid channel and a dry chamber. The arrangement allows active thermal regulation without moving parts, improving fluid flow consistency and reducing waste during sterilization and cleaning processes.

The objects underlying the subject matter of this disclosure are achieved by a valve body and/or by a process valve. Various embodiments can be found in the following description of exemplary embodiments.

One aspect of the description relates to a valve body for a process valve, wherein an opening of the valve body leads to a fixed valve seat, wherein at least two fluid channel portions lead from the fixed valve seat of the valve body into the valve body, wherein at least one wall separates one of the fluid channel portions and at least one dry side of the valve body from one another, and wherein at least one surface on the dry side of the at least one wall is thermally conductively connected to at least one thermoelectric module.

The thermoelectric module allows a compact size of the valve body to be realized. This is in particular important for small sizes. The absence of moving parts reduces the maintenance effort of the valve body, and the operation and assembly of the valve body also do not require any additional measures. In addition, the thermoelectric module is suitable for precise temperature regulation in conjunction with a regulated supply voltage. In comparison to traditional cooling methods, such as heat exchangers and pumps, energy efficiency is improved.

In comparison to other cooling/heating systems, the thermoelectric module does not require any coolant or cooling fluid and therefore does not need to be left to rest before commissioning. The valve body can be installed in any position and orientation without consideration having to be given to the thermoelectric module.

The Peltier effect allows the thermoelectric module to be used as a heater or cooler by reversing the current direction.

During operation, the desired setpoint temperature of the process fluid is maintained. The aim is thus to ensure that the warm medium is not cooled down unintentionally, so that, for example, pasty and highly viscous media remain flowable. In particular, the flowability of highly viscous process media in the food and cosmetics sectors is thus improved through temperature control.

Advantageously, the cleaning of the process valve can also be improved. For example, the process plant is heated to over 100° C. in a cleaning cycle. For sterilization purposes, a temperature of over 100° is maintained for a certain period of time. For this purpose, hot steam is first sent through the system and thus also through the valve. The first valves and components in the flow direction are therefore heated first. The last valves toward the exit of the system are the last to be brought to the setpoint temperature for sterilization. Sterilization is supported by preheating the last valves in the system in order to support the sterilization process and shorten its duration.

A cooling process following the heating of the system can be reduced, for example, from hours to 20-30 minutes or from 10 minutes to 1 minute by active cooling by at least one thermoelectric module. Cooling by the process fluid, which is treated as waste, can also be eliminated or reduced. This reduces product waste and shortens the cleaning time.

In one example, the at least one surface on the dry side of the at least one wall follows a plane at least in portions.

Advantageously, a planar surface simplifies direct contact with the at least one thermoelectric module or another thermal-energy-conducting element. Peltier elements in particular have planar contact surfaces, with the planar surface making assembly possible in the first place and also simplifying it.

In one example, the at least one surface of the at least one wall is arranged on the dry side of the valve body that is opposite the opening of the valve body that leads to the fixed valve seat

Advantageously, an area of the valve body that is facing away from the actuator side of the valve body is used for cooling. This creates constructive degrees of freedom in the design of the temperature control of the valve body.

In one example, the at least one thermoelectric module is arranged between the at least one wall and at least one heat exchange element.

Advantageously, the heat exchange element allows cold or heat to be dissipated more efficiently from the thermoelectric module, which improves the temperature control performance of the thermoelectric module.

In one example, the at least one heat exchange element has an outer heat exchange surface, and wherein the outer heat exchange surface is part of a housing of the valve body at least in portions.

This improves heat dissipation to the outside air. In addition, in this example, ventilation openings leading into an interior or dry space of the valve body can be dispensed with. The cleanability of the valve body is increased.

In one example, a thermal insulator is arranged between the at least one heat exchange element and a main body of the valve body which delimits the at least two fluid channel portions and provides the fixed valve seat.

The thermal insulator improves the cooling or heating effect of the thermoelectric module. This is because a main body made of a metal alloy, for example, is heated or cooled quickly by the medium flowing through it. In order to generate a corresponding opposite thermal effect, the insulator ensures that the thermally insulated outer heat exchange element makes transport of thermal energy possible independently of the temperature of the main body, thus improving the cooling or heating effect.

In one example, at least one heat-conducting element is arranged between the at least one thermoelectric module and the heat exchange element.

Advantageously, the at least one heat-conducting element reduces the thermal resistance between the thermoelectric module and the heat exchange element, which means that the thermal energy flow between the thermoelectric module and the heat exchange element is improved.

In one example, the valve body comprises at least one active fan, which is configured to generate an air flow during operation, which air flow is guided past the heat exchange element and/or the thermoelectric module.

The active fan can improve dissipation of thermal energy.

In one example, the at least one heat exchange element has a heat exchange surface, and wherein the heat exchange surface is arranged within a dry space of the valve body.

Advantageously, thermal energy present in the heat exchange element can be exchanged with the air in the dry space.

In one example, an outer wall of the valve body has at least one ventilation opening, which leads from the outside into the dry space of the valve body.

In this way, outside air can enter the dry space and be used to dissipate heat or cold.

In one example, the valve body, in particular the main body, comprises at least one temperature sensor, which generates a signal that characterizes a current temperature of the valve body.

The temperature of the valve body can be measured, which temperature also affects the fluid to be provided.

In one example, a control circuit is present, which is configured to operate the at least one thermoelectric module by means of an operating current.

A further example is characterized in that the control circuit is integrated in the valve body.

In one example, the control circuit is configured to ascertain the operating current on the basis of a specified setpoint temperature and the current temperature of the valve body.

A further aspect of the description relates to a process valve comprising the valve body according to the previous aspect, at least one shut-off unit, and at least one valve actuator, wherein the valve actuator moves the shut-off unit via an actuator rod between an open position in which process fluid can flow through a fluid channel and a closed position in which the flow of process fluid through the fluid channel is interrupted.

Further details and embodiments of the disclosure can be found in the following description, by which embodiments of the disclosure are further described and explained.

### BRIEF DESCRIPTION OF THE DRAWINGS

Further advantages and aspects of this disclosure emerge from the claims and from the following description of preferred exemplary embodiments of this disclosure, which are explained below with reference to the figures. Identical and functionally corresponding elements are provided with identical reference signs. In the drawings:

FIG. 1 is a valve body in a schematic section;

FIG. 2 is an example of the valve body in a perspective view;

FIG. 3 is a further example of the valve body in a schematic section;

FIG. 4 is a different example of the valve body in an exploded view;

FIG. 5 is the example of the valve body of FIG. 4 in a further exploded view;

FIG. 6 is an additional example of the valve body in an exploded view; and

FIG. 7 is a process valve comprising the valve body.

### DETAILED DESCRIPTION

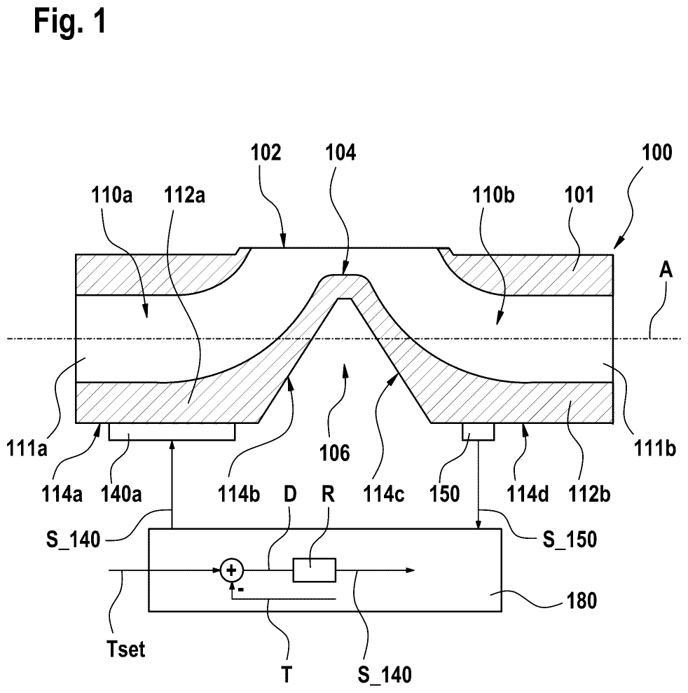

FIG. 1 shows a valve body 100 for a process valve, in particular a diaphragm valve. Examples of the valve body 100 designed for a diaphragm valve are shown below. Of course, the examples shown of the valve body 100 can be easily transferred to other valves, such as seat valves, plug diaphragm valves, ball valves, and other valve types.

An opening 102 of the valve body 100 leads to a fixed valve seat 104, wherein at least two fluid channel portions 110a-b lead from the fixed valve seat 104 of the valve body 100 into the valve body 100. In the example, the fluid channel portions 110a-b lead to a corresponding process fluid connection 111a-b. At least one wall 112a-b separates one of the fluid channel portions 110a-b and at least one dry side 106 of the valve body 100 from one another, wherein at least one surface 114a on the dry side 106 of the at least one wall 112a is thermally conductively connected to at least one thermoelectric module 140a.

As used herein, the term “dry side” refers to a region of the valve body that is isolated from contact with process fluids during normal operation. This space is typically sealed from the fluid channel portions and may house electronic components, control circuits, sensors, and/or thermal regulation elements such as thermoelectric modules.

As used herein, “thermoelectric module” refers to a solid-state device, such as a Peltier element, that generates a temperature gradient across its surfaces when an electric current is applied. It enables active heating or cooling depending on the current direction, and typically includes a series of thermoelectric junctions arranged between electrically insulating substrates.

The thermoelectric module 140a is designed, for example, as a Peltier element. The Peltier element is a solid-state device that uses the thermoelectric effect to generate a temperature difference across its surfaces by conducting an electric current through the solid-state device. This allows cooling or heating of one of the corresponding surfaces without moving parts or liquids.

For example, the Peltier element of the thermoelectric module 140a comprises a plurality of thermoelectric pairs connected in series. Each thermoelectric pair consists of two different semiconductor materials, n-type and p-type, which are connected electrically in series at one end and thermally in parallel at the other end. These pairs are embedded between two ceramic plates, which provide mechanical stability and serve as electrical insulators.

When a direct electrical current flows through the Peltier element of the thermoelectric module 140a, heat is absorbed at one connecting piece of the thermoelectric pairs and dissipated at the other connecting piece, resulting in cooling on one side of the element and heating on the other side. This process is known as the Peltier effect.

The temperature difference generated by the thermoelectric module 140a can be precisely controlled by changing the current direction and current intensity.

For example, the thermoelectric module 140a is connected to the surface 114a by means of a thermally conductive adhesive.

A sensor 150 generates a signal S_150 that characterizes a current temperature T of a main body 101 of the valve body 100. For example, the at least one temperature sensor 150 contacts the surface 114d on the dry side 106 of the wall 112b.

The main body 101 is made of a metal alloy, for example.

A control circuit 180 is configured to operate the at least one thermoelectric module 140a by an operating current S_140.

The operating current S_140 is in particular direct current, wherein the current direction determines the direction of transport of the thermal energy through the thermoelectric module 140a. A first current direction generates a cooling effect of the valve body 100, i.e., thermal energy is removed from the valve body 100. A second current direction generates a heating effect of the valve body 100, i.e., thermal energy is introduced into the valve body 100.

The control circuit 180 is integrated in the valve body 100, implemented externally, or a first part of the control circuit 180 is located in the valve body 100 and a second part of the control circuit 180 is located outside the valve body 100.

The control circuit 180 is configured to ascertain the operating current S_140 on the basis of a specified setpoint temperature Tset and the current temperature T of the valve body 100.

As used herein, “setpoint temperature” refers to a predetermined or dynamically calculated target temperature used by the control circuit to regulate operation of the thermoelectric module.

For example, the setpoint temperature Tset is specified by a higher-level system control and compared with the current temperature T according to the signal S_150. A difference D between the setpoint temperature Tset and the temperature T is formed and fed to a regulator R. The regulator R ascertains the operating current S_140 on the basis of the difference D.

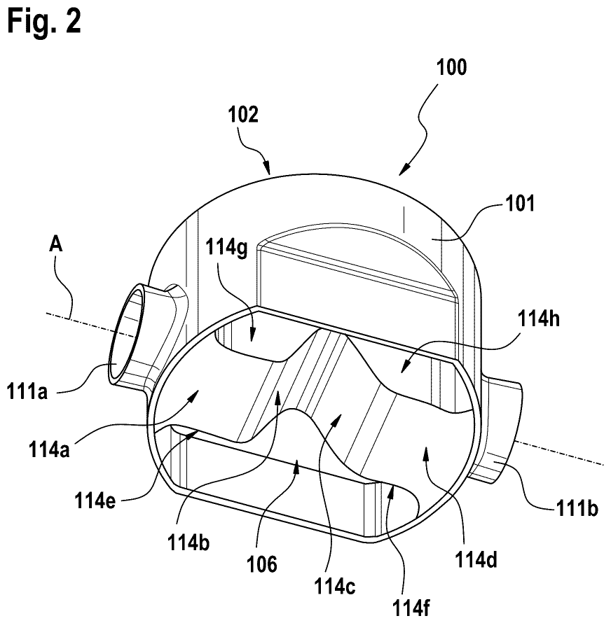

FIG. 2 shows the main body 101 of the valve body 100 in a perspective view, allowing a view into a dry space on the dry side 106. The at least one surface 114a-h on the dry side 106 of the at least one wall 112a-b follows a plane at least in portions.

As used herein, “dry space” refers to an interior region of the valve body that is physically separated from process fluid flow paths, intended to house electrical or control components without exposure to fluid or contamination.

The at least one surface 114a-h of the at least one wall 112a-b is arranged on the dry side 106 of the valve body 100 that is opposite the opening 102 of the valve body 100 that leads to the fixed valve seat 104.

At least two surfaces 114a, 114d or 114g, 114h of the walls 112a-b of different fluid channel portions 110a-b extend along a common imaginary plane. This not only saves installation space but also simplifies the design of the connection to heat-conducting components.

The at least one surface 114a, 114d, 114e-h extends in parallel with a central longitudinal axis A of at least one of the fluid channel portions 110a-b.

The at least one surface 114b, 114c follows a corresponding plane through which an imaginary extension of the central longitudinal axis A of at least one of the fluid channel portions 110a-b extends. Both surfaces 114b-c taper the dry space toward the valve seat 104.

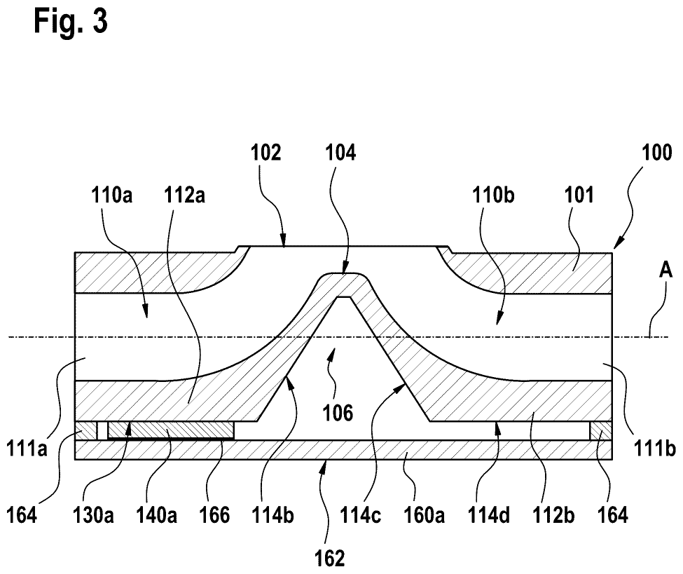

FIGS. 3, 4, 5 show further examples of the valve body 100. The at least one thermoelectric module 140a, 140d is arranged between the at least one wall 112a-b and at least one heat exchange element 160a.

As used herein, a “heat exchange element” refers to a component that facilitates the transfer of thermal energy between the thermoelectric module and the surrounding environment, such as via conduction or convection. It may include planar plates, finned structures, or other geometries to increase thermal transfer surface area.

The at least one heat exchange element 160a comprises an outer heat exchange surface 162, wherein the outer heat exchange surface 162 is part of a housing of the valve body 100 at least in portions.

At least one heat-conducting element 166 is arranged between the at least one thermoelectric module 140a-h and the heat exchange element 160a-h and makes conduction of thermal energy between the thermoelectric module 140a, 140d and the heat exchange element 160a-h possible.

As used herein, a “heat-conducting element” refers to a component positioned between the thermoelectric module and the heat exchange element to reduce thermal resistance. It may include thermally conductive paste, adhesive, or metal plates that improve heat flow across interfaces.

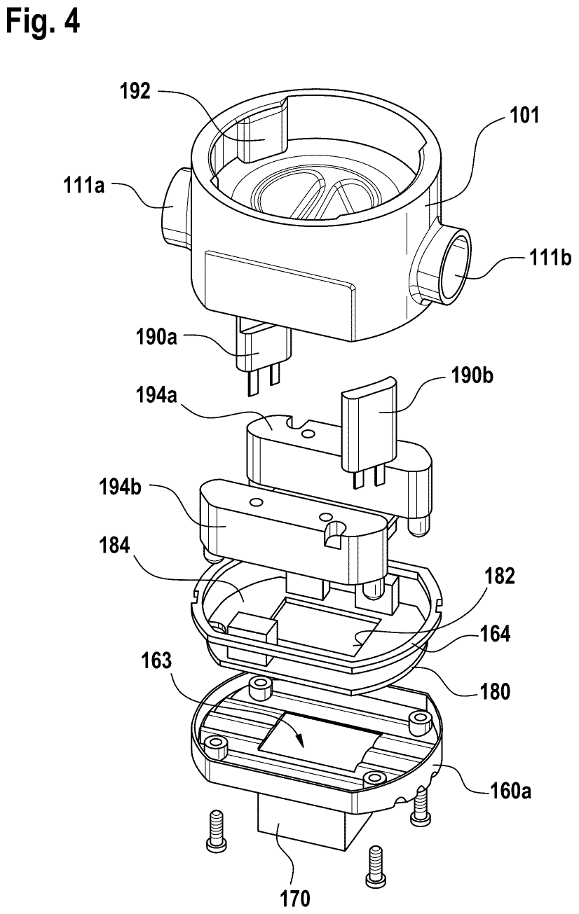

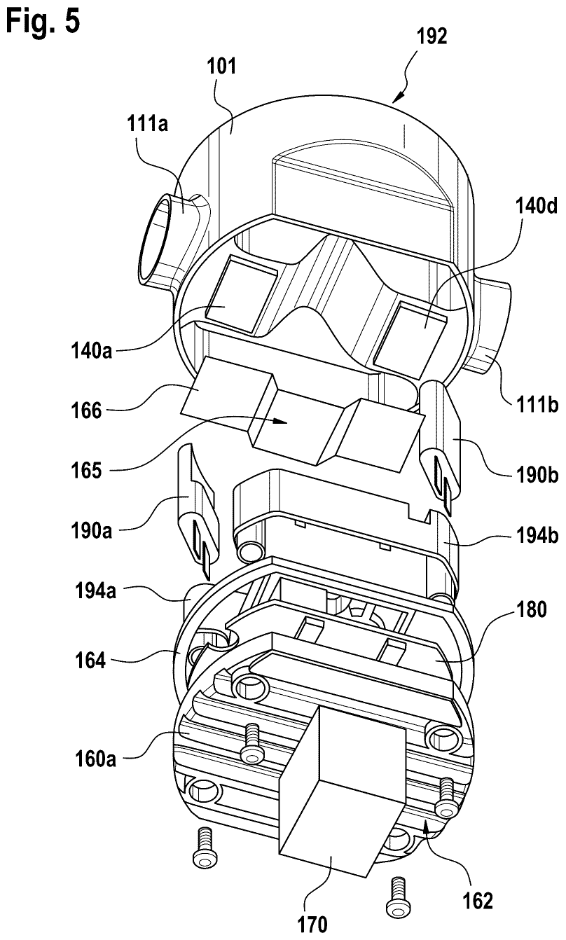

For example, the thermoelectric module 140a is thermally connected to the heat exchange element 160a by means of the heat-conducting element 166, such as a thermal paste in FIG. 3 or a metallic heat-conducting plate in FIGS. 4 and 5.

A thermal insulator 164 is arranged between the at least one heat exchange element 160a and the main body 101 of the valve body 100, which delimits the at least two fluid channel portions 110a-b and provides the fixed valve seat 104.

As used herein, “thermal insulator” refers to a material or structure with low thermal conductivity, positioned to restrict heat flow between the heat exchange element and the valve main body. It helps to localize heating or cooling effects.

The thermal insulator 164 comprises at least one plastic and/or at least one elastomer as material.

In all examples described, the thermal insulator 164 is, for example, partially light-transmissive. The control circuit 180 is connected to light sources arranged in the dry space, which illuminate the thermal insulator 164 with light.

In one example, the light sources are operated by the control circuit 180 in such a way that they emit red light when the main body 101 is heated. This means that the heating is visible from the outside.

In a further example, the light sources are operated by the control circuit 180 in such a way that they emit blue light when the main body 101 is cooled. This means that the cooling is visible from the outside.

With reference to FIGS. 4 and 5, the heat-conducting plate is designed in a stepped manner in the sense of the heat-conducting element 166 and connects the two thermoelectric modules 140a and 140d to an inner surface 163 of the heat exchange element 160a. For this purpose, a circuit board 184 of the control circuit 180 comprises a through-opening 182. The heat-conducting element 166 extends through the through-opening 182 in order to provide thermal coupling between the thermoelectric modules 140a and 140d and the heat exchange element 160a acting as the end cover. The inner surface 163 is thermally conductively connected to a contact surface 165 of the heat-conducting element 166.

In an example not shown, the circuit board 184 is omitted. Alternatively, the area of the circuit board 184 that lies directly, e.g., in a direct path, between the thermoelectric module 140a, 140d and the heat exchange element 160a is removed from the circuit board 184. This means that a differently designed heat-conducting element is located between each thermoelectric module 140a, 140d and the heat exchange element 160a.

At least one electrical contact element 190a-b is electrically connected to the control circuit 180 in the assembled state of the valve body 100 and provides electrical contacts in the area of the actuator interface 192 in order to supply the control circuit with electrical energy and data from the actuator side via mating contacts. This means that no connectors are exposed in the area of the valve body 100 in the assembled state of the process valve.

At least one fastening element 194a-b on the dry-room side is arranged between the main body 101 and the heat exchange element 160a. The at least one fastening element 194a-b fixes the associated at least one electrical contact element 190a-b to the main body 101.

The valve body 100 comprises at least one active fan 170, which is configured to generate an air flow during operation, which air flow is directed past the heat exchange element 160a-h.

The active fan 170 can of course also be omitted and passive cooling can be realized.

The active fan 170 comprises, for example, an axially or radially flowed-through impeller driven by an electric motor, which impeller is arranged to rotate in its own housing.

With reference to FIGS. 3-5, the valve body 100 is hermetically sealed to the outside.

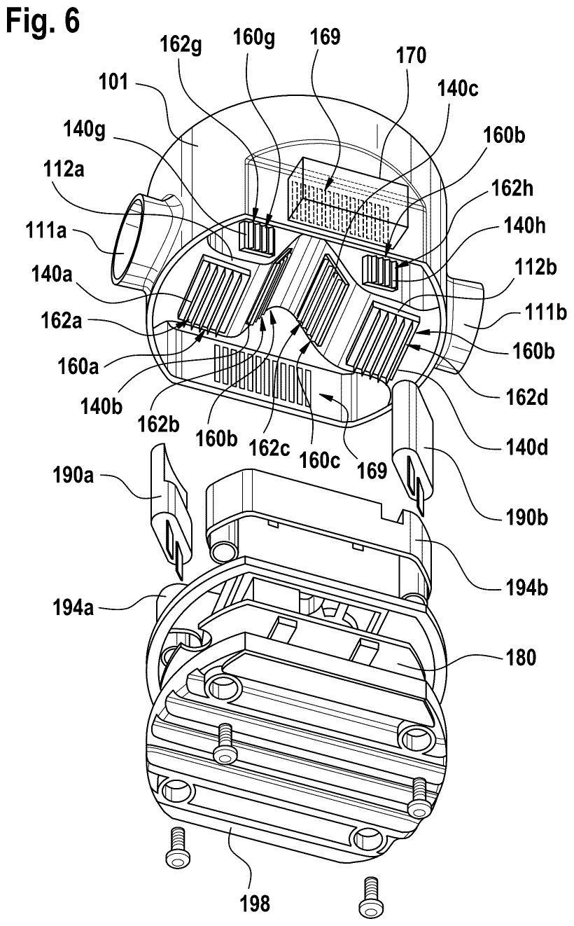

FIG. 6 shows a further example of the valve body 100 that is not hermetically sealed to the outside, but its outer wall comprises at least one ventilation opening 169, which leads from the outside into the dry space of the valve body 100.

In the present example, a plurality of ventilation openings 169 in the sense of a ventilation grille is introduced into the outer wall on both sides of the main body 101.

A cover 198 closes the valve body 100 on the side facing away from the actuator.

In the present example, the active fan 170 is mounted outside the main body 101 on the ventilation grille. Of course, the active fan can also be arranged within the dry space.

The at least one thermoelectric module 140a-h is arranged between the at least one wall 112a-b and the at least one heat exchange element 160a-h.

The at least one heat exchange element 160a-h comprises heat exchange surfaces 162a-h, which are formed by cooling fins in the present case. The cooling fins are glued onto the corresponding thermoelectric module 140a-h, for example.

The at least one heat exchange element 160a-h has a larger total heat-effective surface area on the side facing away from the associated wall 112a-b than on the side facing the associated wall 112a-b.

The thermoelectric modules 140e and 140f and the associated heat exchange elements are not visible in FIG. 6 due to the perspective shown.

The thermal insulator 164 in FIG. 6 is arranged between the at least one cover 198 and the main body 101 of the valve body 100, which delimits the at least two fluid channel portions 110a-b and provides the fixed valve seat 104.

The at least one thermoelectric module 140a-h is arranged between the at least one wall 112a-b and at least one heat exchange element.

The at least one heat exchange element 160a-h has an outer heat exchange surface 162a-h through a cooling fin structure, wherein the outer heat exchange surface 162a-h is used to transport thermal energy by air convection.

The at least one heat exchange element 160a-h thus comprises a heat exchange surface 162a-h facing away from the at least one thermoelectric module 140a-h, wherein the heat exchange surface 162a-h is arranged within a dry space of the valve body 100.

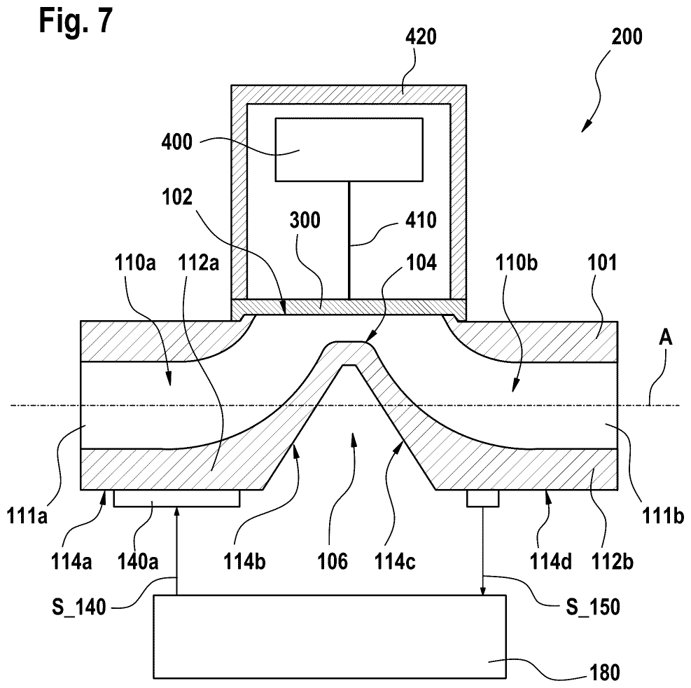

The diaphragm valve 200 shown in FIG. 7, which is generally referred to as a process valve, comprises the valve body 100. The at least one valve diaphragm 300 can also be referred to as a shut-off unit. In the example shown, the valve diaphragm 300 closes the opening 102 leading to the fixed valve seat 104 and thus delimits a fluid channel comprising the at least two fluid channel portions 110a-b. In another example, the shut-off unit is not clamped between the edge of the opening 102 but is movably arranged within the process valve in order to be pressed onto the valve seat.

At least one valve actuator 400 moves the shut-off unit, in the present case the valve diaphragm 300, via an actuator rod 410, between an open position in which process fluid can flow through the fluid channel and a closed position in which the flow of process fluid through the fluid channel is interrupted.

The valve actuator 400 comprises a housing 420, which is supported on the valve body 100 and clamps the valve diaphragm between the housing 420 and the area of the valve body 100 that surrounds the opening 102.

To the extent not already described, the different features and structures of the various embodiments can be used in combination, or in substitution with each other as desired. That one feature is not illustrated in all of the embodiments is not meant to be construed that it cannot be so illustrated, but is done for brevity of description. Thus, the various features of the different embodiments can be mixed and matched as desired to form new embodiments, whether or not the new embodiments are expressly described. All combinations or permutations of features described herein are covered by this disclosure.

Persons skilled in the art will understand that the structures and methods specifically described herein and shown in the accompanying figures are non-limiting exemplary aspects, and that the description, disclosure, and figures should be construed merely as exemplary of aspects. It is to be understood, therefore, that the present disclosure is not limited to the precise aspects described, and that various other changes and modifications can be effected by one skilled in the art without departing from the scope or spirit of the disclosure. Additionally, the elements and features shown or described in connection with certain aspects can be combined with the elements and features of certain other aspects without departing from the scope of the present disclosure, and that such modifications and variations are also included within the scope of the present disclosure. Accordingly, the subject matter of the present disclosure is not limited by what has been particularly shown and described.

What is claimed:

1. A valve body for a process valve, comprising:
an opening that leads to a fixed valve seat;
at least two fluid channel portions extending from the fixed valve seat into the valve body;
at least one wall separating one of the fluid channel portions from a dry side of the valve body; and
at least one surface on the dry side of the at least one wall thermally conductively connected to at least one thermoelectric module configured as a Peltier element.

2. The valve body of claim 1, wherein the at least one surface follows a plane, at least in portions.

3. The valve body of claim 1, wherein the at least one surface is positioned on the dry side opposite the opening that leads to the fixed valve seat.

4. The valve body of claim 1, further comprising at least one heat exchange element positioned between the at least one wall and the at least one thermoelectric module.

5. The valve body of claim 4, wherein the at least one heat exchange element includes an outer heat exchange surface that is part of a housing of the valve body.

6. The valve body of claim 5, further comprising a thermal insulator positioned between the heat exchange element and a main body of the valve body that defines the fluid channel portions and the fixed valve seat.

7. The valve body of claim 3, further comprising at least one heat-conducting element arranged between the thermoelectric module and the heat exchange element.

8. The valve body of claim 4, further comprising at least one active fan configured to generate an airflow past the heat exchange element and/or the thermoelectric module during operation.

9. The valve body of claim 2, wherein the heat exchange element has a heat exchange surface positioned within a dry space of the valve body.

10. The valve body of claim 1, wherein an outer wall of the valve body includes at least one ventilation opening leading from outside into the dry space of the valve body.

11. The valve body of claim 1, further comprising at least one temperature sensor configured to generate a signal characterizing a current temperature of the valve body.

12. The valve body of claim 1, further comprising a control circuit configured to operate the thermoelectric module via an operating current.

13. The valve body of claim 12, wherein the control circuit is integrated into the valve body.

14. The valve body of claim 12, wherein the control circuit is configured to determine the operating current based on a specified setpoint temperature and the current temperature of the valve body.

15. A process valve comprising: the valve body of claim 1;
at least one shut-off unit; and
at least one valve actuator configured to move the shut-off unit via an actuator rod between an open position, in which process fluid flows through a fluid channel, and a closed position, in which flow of process fluid is interrupted.
